(19) United States
(12) Patent Application Publication
(10) Pub. No.: US 2007/0067180 A1
(43) Pub. Date: Mar. 22, 2007

(54) Property rating and ranking system and method

(75) Inventors: Ian David Charles James, Brighton East (AU); Malcolm William Latham James, Brighton (AU)

Correspondence Address: PATTON BOGGS, L.L.P., 2001 ROSS AVENUE, SUITE 3000, DALLAS, TX, 75201, US

(73) Assignee: Property Ratings Pty Ltd

(21) Appl. No.: 11/598,946

(22) Filed: Nov. 14, 2006

Related U.S. Application Data
(63) Continuation of application No. PCT/AU06/01256, filed on Aug. 30, 2006.

(30) Foreign Application Priority Data
Aug. 20, 2006 (WO) PCT/AU06/01256
Sep. 19, 2005 (AU) 2005905149

(51) Int. Cl. G06Q 99/00

(52) U.S. Cl. 705/1

(57) ABSTRACT

The present invention relates to the field of property or real estate. In one form, the invention relates to the rating of property. In another form, the present invention relates to the ranking of property based on various inputs into the system and method of the present invention. The rating and/or ranking is determined in accordance with a numerical value.

### FIELD OF INVENTION

The present invention relates to the field of property or real estate.

In one form, the invention relates to the rating of property.

In another form, the present invention relates to the ranking of property based on various inputs into the system and method of the present invention.

It will be convenient to hereinafter describe the invention in relation to property rating, however it should be appreciated that the present invention is not limited to that use only.

### BACKGROUND ART

The discussion throughout this specification comes about due to the realisation of the inventors and/or the identification of certain prior art problems.

Property represents a relatively large proportion of most individuals “wealth” and in the most part a very large part of the worlds “wealth”. The inventors have realised that most people buy one or more properties with three reasons in mind:
to live in, and/or
to work in, and/or
to use for investment purposes.

The inventors have realised that most people who sell property do so in a way to maximise their opportunities in the future.

It is considered that, in terms of wealth creation, buyers who do this are commercially better off than people who do not buy one or more properties. It is also considered that buyers and/or sellers who do this well are commercially better off than buyers and/or sellers who do this poorly. It is therefore apparent that tools which are perceived to assist a buyer and/or a seller to make a good decision when buying property are of commercial significance.

However, it has been found that the existing methods of determining whether the transaction of a property represents a ‘good decision’ for a buyer or seller are currently considered to be relatively haphazard in as much as they are based on:

1. Sellers Asking Price—Using a sellers criteria which is considered very limited, for example,
a. What the sellers thinks he can get, which is often relatively inflated based on the sellers ‘hope’ to attain a certain price or value;
b. What the agent believes the seller can get, which may be based equally on a desire to engage the seller, and/or
c. What other sale prices there are in the area, although these are often based on property having different criteria, so assumptions of the relevance of the property to the present property transaction are made by the seller or buyer)

2. Sold Price—What one person was willing to pay another, which may also depend on many factors, and not necessarily ‘value’ alone;

3. Valuation—A more detailed and more methodical approach but the criteria have been found to not relate to an individual purchasers needs—they relate to the property alone and they are expressed as a dollar amount which can vary dramatically. Also the ‘valuation’ may be made on a relatively conservative basis, and may vary with the perceived time based on a property cycle (‘boom’ or ‘bust’);

4. Buyers needs—A number of books are available which encourage an individual to think about via checklists. The checklists have been found to vary and don't give clear indications as to the ranking or rating of the criteria for decision and how they will vary between each individual; and

5. Median Prices—which is considered to be only a very small part of a property fundamental

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to a relatively more consistent property rating system and/or method.

A further object of the present invention is to alleviate at least one disadvantage associated with the prior art.

### SUMMARY OF INVENTION

The present invention provides, in an aspect of invention, an apparatus adapted to and/or method of calculating a property rating attributable to a property, the method comprising the steps of determining assessment criteria for use in the rating, attributing a first numerical value to at least a portion of the assessment criteria, providing a second numerical value to the at least a portion of assessment criteria, and determining the rating according to the second numerical value.

The present invention provides, in another aspect of invention, an apparatus adapted to and/or method of ranking a plurality of properties, the method comprising the steps of calculating a first rating corresponding to a first property, calculating a second rating corresponding to at least a second property, and correlating the first and second ratings based on a numerical value.

The present invention provides, in further aspect of invention, a method of and/or an application adapted to determine a property rating, the application comprising first selection means adapted to enable a determination of assessment criteria for use in the rating, second selection means adapted to attribute a first numerical value to at least a portion of the assessment criteria, and logic means adapted to record a second numerical value corresponding to the at least a portion of assessment criteria, and to determine the rating according to the second numerical value.

The present invention provides, in a still further aspect of invention, a method of and/or an application adapted to provide a ranking a plurality of properties, the application comprising enabling a first rating to be calculated corresponding to a first property, enabling a second rating to be calculated corresponding to at least a second property, and correlating the first and second ratings based on a numerical value.

The present invention provides, in another aspect of invention, a rating attributable to a property, the rating comprising a numerical value based on user input.

The present invention provides, in again another aspect of invention, a system adapted to provide a property rating, the system including an application as herein disclosed.

Other aspects and preferred aspects are disclosed in the specification and/or defined in the appended claims, forming a part of the description of the invention.

In essence, the invention is a universal objective rating system for any property, in any location, that allows multiple properties to be rated and ranked against each other and also according to individual's specific needs and requirements.

In a still further aspect, the invention relates to the rating of property with regards to any one or any combination of:
an individual's needs. YOUR NEEDS RATING. (subjective and flexible)
various inputs, such as PROPERTY CHARACTERISTICS RATING (objective and consistent)
user and other opinions made with regards to purchase price MONEY RATING

The present invention is predicated on the realisation that the use of a more numerical rating system, whether or not provided in conjunction with various graphical representations, can provide a system and/or method of property rating which assists buyers and/or sellers of property in:
1. Helping a buyer or seller understand the process involved in transacting and highlighting the individual's skills and weaknesses prior to starting the process.
2. Helping a seller determine which agent to choose
3. Helping a buyer decide if a property warrants his or her consideration by allowing a consistent assessment of it's attributes against the buyer's needs criteria and
4. Then deciding if others share similar views to the buy/seller in terms of what is a ‘good’ property or ‘bad’ property when assessed by the generally accepted long term DEMAND and SUPPLY criteria;
5. Helping a seller assess the level of overall attractiveness of their property in relation to specific buyer criteria
6. Comparing different available properties with regards to 1 above in a consistent manner and then having that comparison expressed in a non literary way such as numbers, colours, stars and graphs thus allowing for more concise decisions;
7. Comparing different available properties with regards to the needs of the buyer and/or seller;
8. Comparing similar available properties that meet the needs of the buyer/seller but which have different characteristics;
9. Allowing comparisons other than price of similar and/or different properties sold in different cycles or sold in unusual circumstances (i.e. very high or low prices);
10. Determining and/or expressing an assessment of a property in a way outside the ‘usual’ manner of assessing property, for example sold price, type of home, size of land;
11. Allowing more meaningful and therefore accurate price comparisons by allowing the matching of highly rated properties with other highly rated properties and poor properties with other poor properties based on a consistent characteristic rating system.
12. Making decisions based, at least in part, on those assessments of as herein disclosed;
13. Relating/comparing the assessments of Property Characteristics, Specific Buyers Needs, the Sellers asking price to assist in the final decision making process with regards to each property.
14. Assist a Buyer or Seller to understand and match their target buy or sell price against their risk profile

The present invention has been found to result in a number of advantages, such as:
An ability to express complicated information inputs in a manner that a user can easily comprehend irrespective of their level of experience in property transactions.
An ability to consistently view at a glance the ranking of a property against newly marketed or newly discovered properties that have been added to a buyers list for consideration.
An ability to preselect rating criteria therefore giving a graphical represented ranking and/or rating for any property and that representation specifically relates to the user's requirements.
The inability to easily change the Property Characteristics Rating thus giving consistent ratings over time for different properties.
An ability to change the weighting of the users YOUR NEEDS as they progress through the process and discover more about their requirements
An ability to point score the selected criteria thus giving consistency due to the use of numerical based rating.
An ability to quickly sort and reduce from 1000's to a handful the number of properties worthy of consideration according to the user's specific requirements.
Can be used by buyer and/or seller
Users (buyers and/or sellers) can make relatively consistent decisions
Can be used by a professional advisor to give assistance to clients to allow more accuracy in assessment and recommendation of specific purchases be they for investment or personal (buyers and/or sellers). This will allow and encourage a higher quality of advice to be given by those genuinely wanting to give good property advice to their clients.
Can be used to compare very different properties Eg (an apartment in England to a house in Australia) on a large number of criteria other than Sellers Asking Price alone and in a measurable manner
Can compare similar properties (eg the same type with different property characteristics) to ascertain which is the most suitable for the buyer
Enables a buyer or seller to make decisions as to whether or not a property is worthy of consideration and at what price.
Can be used as a means of advertising the characteristics of a property which have been weighted and expressed in a consistent manner (eg via a numerical figure and star rating in additional to the price and advertising comment)
A media organisation or marketing company can use part of the property ratings system to allow a consistent & quick comparison other than seller asking price.
Helping to choose an agent on performance related criteria.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates an embodiment of the present invention,

FIG. 2 illustrates another embodiment of the present invention,

FIG. 3 illustrates still another embodiment of the present invention,

FIG. 4a illustrates, in more detail, an embodiment of the present invention,

FIG. 4b illustrates an example of a property rating result in accordance with an embodiment of the present invention,

FIG. 5 illustrates an example of a graphical and numerical rating expression.

FIG. 6 illustrates an example of the visual display of the ranking of a number of properties, and

FIG. 7 illustrates a web site based embodiment of the present invention.

### DETAILED DESCRIPTION

The various embodiments disclosed in this specification are expressed and represented for the purpose of illustration only as a flow chart. The invention may be embodied in a corresponding method and/or system adapted to perform the present invention.

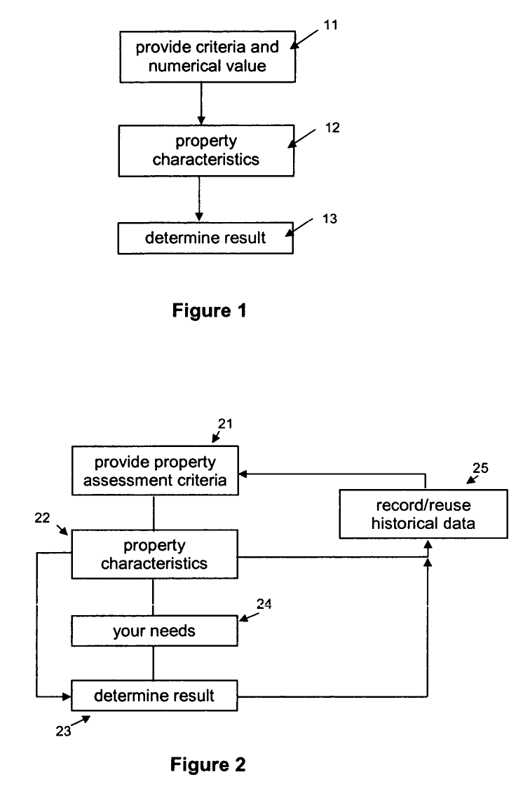

FIG. 1 shows an embodiment of the present invention. The various criteria for assessment 11, and the manner in which the criteria will be rated or valued in the performance of the assessment needs to be provided. The various property characteristics 12 need to be provided. Lastly, the result may be determined 13 by assessing the property characteristics 12 provided in accordance with the assessment criteria 11.

In accordance with an embodiment of the invention, there may be provided different property characteristics depending on the type of property to be evaluated according to the present invention. For example, the property characteristics used may be based on a predetermined set of property characteristics, each set reflecting one or more of the property characteristics for:
a relatively large house
a relatively small house
a relatively medium house
a relatively small unit/townhouse
a relatively large unit/townhouse
a commercial property
an industrial property
a specialist property like a hobby farm or an island
a vacant block of land

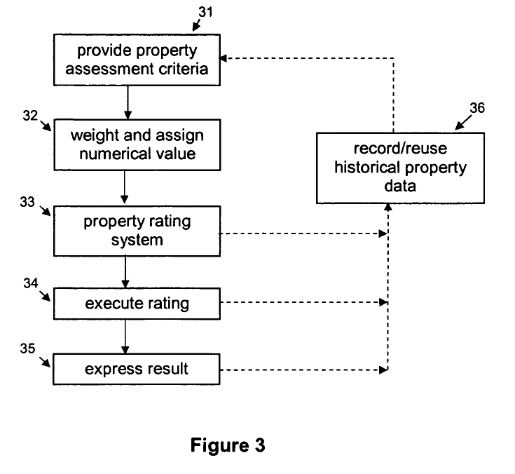

FIG. 2 shows another embodiment of the present invention, in which the various criteria for assessment 21, and the manner in which the criteria will be rated or valued in the performance of the assessment needs to be provided. The various property characteristics 22 need to be provided. Again, the result may be determined 23 by assessing the property characteristics 22 provided in accordance with the assessment criteria 21. The assessment criteria 21 may be based on or may include historical data 25 determined from previous evaluations and/or other known sources. In addition, optionally, the ‘your needs’ characteristics 24 may be evaluated in addition to the property characteristics 22. It is to be further noted that the ‘your needs’ may be performed before the ‘property characteristics’.

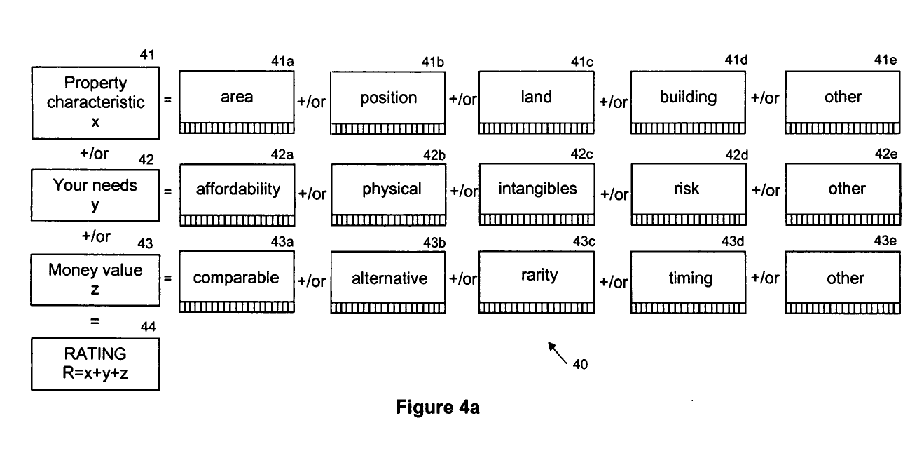

FIG. 3 illustrates still another embodiment of the present invention. Initially, the various property assessment criteria 31 need to be collated. These criteria may include, without limitation, any one or any combination of:
information regarded by “the experienced property community” as important in making a decision,
information which is considered not to be included in the rating;
historical data 36, for example stemming from information given and/or generated at other steps in the present invention, records of comparisons over time, records of comparisons over time with very different fundamentals and/or other sources of historical data; and/or
a selection of any of property characteristics, your needs, money value and the various attributes encompassed therein.

Following this, the criteria 31 is weighted and assigned a numerical value 32. This may take into account various property and/or buyer/seller information, such as without limitation, any one or any combination of:
its importance with regards to the specific ‘Your Needs’ of the buyer/seller and their own individual requirements;
its importance with regards to the asking price taking into consideration an agreed set of “price” criteria;
Weighing the information according to its importance with regards to each property characteristic and compared to long term DEMAND and SUPPLY criteria

In assigning a numerical value, the importance of the criteria is provided a numerical value. For example, a property's position relative to a train station may be considered by a buyer to be important to them and thus a numerical value of importance of 8 out of a possible value of 10. A numerical value may be of any kind, such as a rating of 1 to 10, or out of 100 or out of 1000 etc.

The value itself, may be altered to reflect the importance of certain assessment criteria, for example in order to bias their importance or to retard their importance in the overall ranking, as may be determined by the user and/or the person undertaking the numerical rating assignment.

In a preferred embodiment, the ‘objective’ assessment criteria such as property characteristics and some of the money value characteristics are given a set or fixed value based on established property long term demand and supply characteristics. It has been advantageously found that the ‘objective’ criteria can be used to provide a comparative assessment between properties in different countries, between different properties, and between different types of properties (such as, for example, between houses and units). The ‘subjective’ assessment criteria, such as ‘your needs’ may be given a user, buyer and/or seller value based on their views or advice.

In an alternate embodiment, the user, buyer and/or seller may set a value each or any of the assessment criteria.

Where a number of properties are considered, it is important that the criteria 31 and weighting and possible values 32 are consistently applied to each property for there to be a meaningful ranking of selected properties.

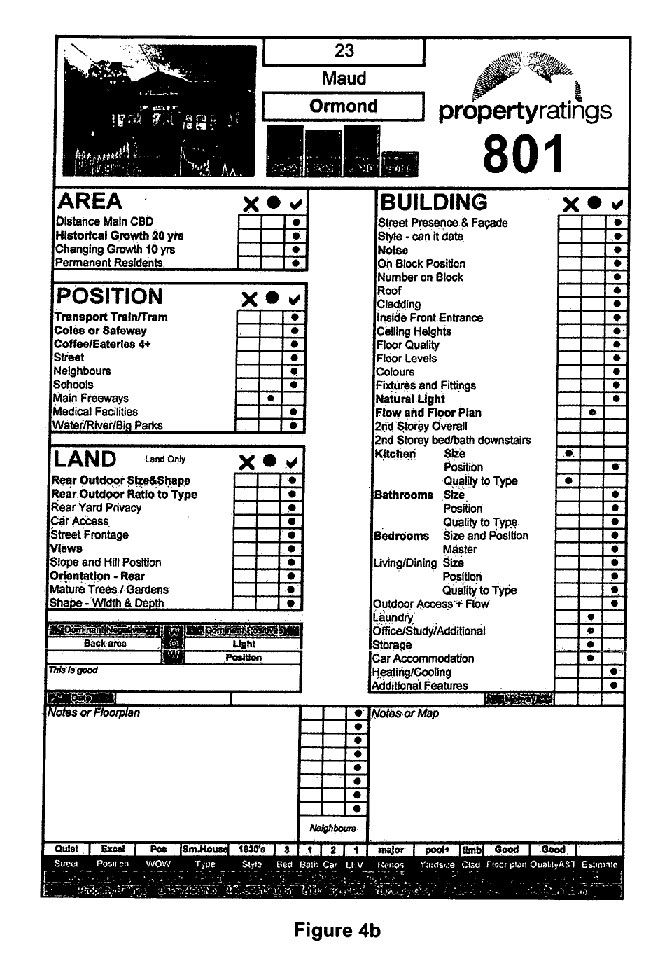

Following steps 31 and 32, a property rating system 33 has been established. Further detail with regard to one embodiment of the system will be described below (eg FIG. 4).

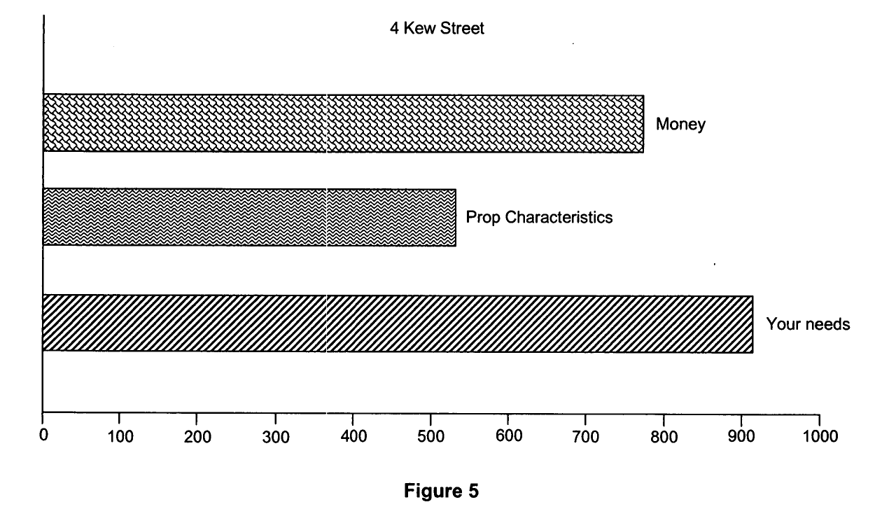

The operation of the system, giving a ranking, can now be undertaken/executed 34. The person using the system will provide their response, for example out of 1 to 10, with regard to the various assessment criteria, using the numerical rating 32. Following this, the calculation and/or the result may be expressed in a suitable format 35. For example, and again without limitation, the result may be expressed as a number (such as this property rating is 768), as a graphical indication within certain categories (ie is rated 4 stars compared to similar rated properties) and/or a combination of both graphical and number (such as this 4 star home with a 768 rating). A representation of such a rating (out of a total of 1000) is illustrated in FIG. 4b. FIG. 5 illustrates an example of a graphical and numerical rating expression (also rated out of a total of 1000).

Example Applications

Focusing on the use of the present invention by a buyer to further explain the present invention, although the present invention has equal application for a seller, a buyer or professional advisor may use the property ratings system as tool of assistance to, for example:
Compare very different properties Eg (an apartment in England to a house in Australia) on a large number of criteria other than Sellers Asking Price alone in a measurable manner. Also to compare say a unit in Queensland with a house in Melbourne.
Compare similar properties eg the same type with different property characteristics or fundamentals to ascertain which is the most suitable for the buyer.
Make decisions as to whether or not a property is worthy of consideration to the individual for owner occupier or investor or a combination of both reasons.
A seller or professional advisor can use part of the property ratings system to advertise the fundamentals or characteristics of a property which have been weighted and expressed in a consistent manner eg via a numerical figure and star rating in additional to the price and advertising blurb.
A media organisation or marketing company can use part of the property ratings system to allow a consistent & quick comparison other than seller asking price.

FIG. 4a illustrates an example implementation of the present invention, being a property rating system 40. The system utilises the calculation of a Rating (R) 44 using any one or any combination of three main categories in any order, namely
PROPERTY CHARACTERISTICS 41
YOUR NEEDS 42, and
MONEY VALUE 43

A number of questions are asked about the property and the user responds with an answer (out of a set of 3 possible answers—yes, no or maybe. Another set of 3 possible answers is good, caution or bad. A third set of possible answers is match, maybe a match, no match. And a fourth set of possible answers is similar, partially similar and dissimilar). Each answer is assigned a numerical value. Preferably questions are asked, and a specific selection of answers (with each possible answer having a set numerical value attributed) are offered, in response to which the user selects one answer, which in turn provides a numerical value in response to the question.

It is also contemplated that a response may be attributed a negative value, that is an assessment criteria, sub-category or category may have a negative value.

For example:
Category 41 ‘property characteristics’ may be assessed in respect of sub-categories, such as area 41a, position 41b, land 41c and building 41d, and/or any other suitable criteria 41e as deemed necessary or as disclosed herein. Category 41 may be thought of in terms ‘objective criteria’ of a buyer and/or seller expressing attributes reflecting whether a property ‘is any good’ or ‘long term demand and supply’ characteristics.
Category 42 ‘your needs’ may be assessed in respect of sub-categories, such as affordability 42a, physical 42b, intangibles 42c and risk 42d and/or any other suitable criteria 42e as deemed necessary or as disclosed herein. Category 42 may be thought of in terms ‘subjective criteria’ of a buyer and/or seller expressing attributes reflecting whether a property ‘is right for me’
Category 43 may be assessed in respect of sub-categories, such as comparable 43a, such as comparable properties or other comparable criteria, alternative 43b, such as alternative properties or other alternative criteria, rarity 43c and timing 43d and/or any other suitable criteria 43e as deemed necessary as disclosed herein. Category 43 may be thought of in terms of a combination of ‘objective and subjective criteria’ of a buyer and/or seller expressing attributes reflecting ‘how much’ a property is or ‘affordability’.

Upon execution of the present invention, a numerical value is attributed in response to each assessment criteria (preferably reflected by way of a question/response), within each sub-category within each category. In accordance with the present invention, each value is then summed, being X summed value for category 41, Y summed value for category 42 and Z summed value for category 43.

In one embodiment, the Rating 44 is given as:
R=any one of or any combination of X, Y Z equation 1

In another embodiment, the Rating 44 is given as:
R=X+Y+Z equation 2
where
X is numerical summed value representing category 41
Y is numerical summed value representing category 42,
Z is numerical summed value representing category 43, and
R may be a summation or other numerical and/or indicia representation of the rating taking into account the result of equation 1 or 2. Alternatively, R may be the lower of any value X, Y or Z.

Furthermore, in calculating R, the property characteristics 41 may be assessed initially, for example, but if the assessment fails to meet a predetermined threshold, then the remainder of the ‘R’ calculation may be abandoned, as the property would be deemed to be unsuitable. This may also or alternatively apply to any one or any combination of X, Y or Z in calculating R.

There need not be any particular order in assessing X, Y and/or Z.

In another embodiment, for example as illustrated in FIG. 5, each category is displayed in a suitable manner, such as by a bar graph. FIG. 5 illustrates a category summed value out of a possible 1000 (numerical value).

It is contemplated that the weightings and/or values may be modified over time. For example, marginally changing with altering views or values of the property market.

Within each sub-category, there are a number of assessment criteria for which a response can be selected. The response may be ‘user friendly’, such as ‘poor’, ‘average’, ‘good’ for which a numerical value can be established or the response may simply be a numerical value (say out of 1 to 100).

Example assessment criteria for the property characteristics category 41 of FIG. 4a may comprise:
Distance from Main City CBD
Historical Capital Growth—20 years
Changing Capital Growth—5 years
Population/Tourists
Demographics/Neighbouring Regions
Actual Legislative Changes
Long Term Supply
Major Entertainment Facilities
Major Hospital Medical Facilities
Access to CBD, International Airport
Public Transport—Train/tram
Major Hospital Access
Improving Access to CBD, Main Airport
Coles or Safeway
Improving Neighbouring Areas/You
Espresso Machine Coffee Shops/Sit Down Dinner Restaurants 4+
Parks Bike Tracks
Street
Street Position
Neighbours
Security
Schools
Distance from Water
Access to Freeway
Comparison to Area Size
Car Access
Street Frontage
Shape Width/Depth
Yard/Garden/Common Areas
Views
Slope and Position on Hill
TYPE—Property to Land Ratio
Position On Block
Style
Street Presence & Entrance
Garaging—Yes/No
Roof
Cladding
Flooring/Carpet
Study/Home Office
Downstairs Bedroom/Ensuite
Floor plan with Flow and Open feeling
Kitchen
Bathroom
Ensuite/2nd Bathroom
Entertaining Patio—Dining Room
Ceilings
Quality
Condition
Bedroom
Upstairs layout
Noise
Storage
Heating Cooling and Insulation
Airflow
New Plumbing
New Electricals and Fittings
Light & Orientation South—Other—North
Name Architect/Builder
Colours
Size
Underfloor
Land size
Building size
Add-ons
Covenants & Easements & Overlays
Pest Rating
Building Inspection Rating
Any other physical assessment criteria and/or objective criteria.
   Example assessment criteria for Your Needs 42 of FIG. 4a are:
Buying Capacity
Ongoing Cashflow
Opportunity Costs
Area
Street
Street Position
Car Access
Land Size
House Size
Type
Style
Cladding
Bedrooms
Bathrooms
Downstairs Bedroom/Ensuite
Floorplan
Quality
Condition
Yard Size
Room for Improvement
Budget
Special
Area
Lifestyle
Experience
Physche
Financial Goals
Family Changes
Assets
Cashflow—LOC—Cross Coll
Tenant
Insurance
Plan and Structure
Length of Hold
Building & Pest
Legal
Passive v Active
Direct v indirect
trading v holding
Reward
Different Risks
Any other buyer and/or seller user desirable attributes selected and/or defined by a user
Any other subjective criteria
   Example assessment criteria for the money value characteristics 43 of FIG. 4a are:
Comparable
   2nd hand similar
   Other Areas
   Without Dominants
   Other Types—similar attributes
   Similar Ratings—Similar Size
Alternative
   2nd hand similar
   Other Areas
   Without Dominants
   Other Types—similar attributes
   Similar Ratings—Similar Size
Area Median
County/State/Territory Median
Trading v Holding
Market Increases
Renovation/Zoning
Comparative Snapshot
Valuing
Timing
RISK
Personal Factors
Any other financial attributes selected and/or defined by the user
Any other subjective and/or objective criteria.

### EXAMPLE ONE

The present invention provides a Property Ratings tool to make property decisions easier, quicker and more accurate. It takes pieces of information from any property and applies relatively consistent numerical formulas to them and then places those information pieces in an ordered fashion to assist the user/buyer to make easier, quicker and more accurate decisions.

The present invention includes an Assessment Tool which can be applied to all properties. All main property characteristics are assessed and a numerical result expressed out of a 1000 (or whatever total is selected). This allows for meaningful comparisons between very different properties while taking into consideration all of their similar and dissimilar features.

Property Ratings assists the user/buyer to answer four questions

1. What Do I Really Want? YOUR NEEDS tool.

2. What are my options? FULL SEARCH MATCHING tool.

3. Is it any good? ASSESS tool.

4. How much—is the money OK? MONEY tool.

Property Ratings can also be applied to a specific user. The explosion of information about properties onto the internet has made buying and selling harder not easier. Property Ratings through its YOUR NEEDS and SEARCH MATCHING tool sorts out the “wrong” and “right” properties for each individual in a very short space of time AND gives the user very clear and definitive guidelines as to its specific relevance to the user/buyer. By looking at the right properties time, money and stress is saved. So how does it work?

Step 1

Answer some simple questions—and a YOUR NEEDS table is developed (see 42 of FIG. 4a).

From this, a shortlist of properties can be developed. The key benefit to the YOUR NEEDS section is that it forces the buyer/user to
A) determine the key criteria they are looking for in a property and then
B) weight those criteria according to the importance they (the user/buyer) place on each criteria.
   This in turn allows decisions to be made because the buyer can then assess and rate each property against a criteria set relevant to him or her instead of looking at a property and wondering what criteria it might match.

During the practical process of buying people change their minds and when they do Property Ratings allows for the criteria and the weighting to be changed. If YOUR NEEDS change or certain criteria require a different weighting this can be done in an instant and a different property shortlist can be created. Each of the criteria is given a numerical weighting.

The criteria and the number or weighting is helpful to the process to this point. It allows simple recommendations to be automated in Step 2 of the process, such as MATCH, POSSIBLE MATCH or NO MATCH.

Step 2

SEARCH MATCHING is the next part of the process. All properties under consideration are matched against the criteria of the buyer/user using a rating. Each property is given a numerical result against the specific criteria of the buyer/user. For example, FIG. 4b shows an example of such a rating. The result is then interpreted against a tolerance that can be adjusted by the buyer/user and expressed as one of three results, namely MATCH, POSSIBLE MATCH or NO MATCH.

Step 3

The user of the present invention can now consider a selected property. The user/buyer is assessing it. The next questions are ‘Is this a good property?’ ‘Do other people like it? ‘Is this a good long term property?’ ‘Does it have good long term demand and supply characteristics?’ The present invention now moves from the subjective and what is specific to the buyer/user to objectives and what is general to all buyers of properties. ‘IS THIS A GOOD PROPERTY?’—ASSESS.

Whilst the ASSESS feature acknowledges that more due diligence should be done before a final decision to purchase, the Property Ratings ASSESS feature allows for a property to be assessed in a relatively short time and its strength and weaknesses highlighted so as a quick decision can be made to pursue or not.

The assessment is carried out by splitting the residential properties into 6 types, namely (for example):
Small Apartment,
Large Apartment,
Small House,
Medium House and
Large House
Vacant Land

However for commercial and industrial and specialist properties there are different types

But also allows comparisons within and outside the types. The criteria set in the ASSESS process is fixed and split into 4 Main categories from which the property is assessed against a number of sub criteria, namely:
AREA,
POSITION,
LAND and
BUILDING.

An example of this is shown if FIG. 4b. Each of these has sub criteria such as for Land Block size compared to Area Type, Orientation, Slope and so on.

The property under assessment is rated against criteria in which it is given a rating of:
Poor (a ‘cross’ in FIG. 4b),
caution (a ‘dot’ in FIG. 4b) or
good rating (a ‘tick’ in FIG. 4b).

The ratings criteria for poor, caution or good are preferably fixed. An example for Train/Tram within Position rating, is the a ‘cross’ is given if the tram/train position is greater than 3 km, a ‘dot’ is given if the tram/train position is between 3 and 1.6 km away, and a ‘tick’ is given if the tram/train position is less than 1.6 km from the property. These ratings preferably have all been assigned fixed scores. A full rating has the property assessed against every criteria set. Once a rating is completed, a numerical figure out at 1000 (or out of a total numerical figure) is given and this allows the buyer/user to, for example:
compare ALL properties against each other
compare the properties you are looking at against each other
know what most other buyers think of your property
know the long term growth potential of each property
know whether the targeted property is any good or not.

Another strength of the present invention is that it lessens the chance of a user/buyer buying an overall poor property with one dominating good feature or missing a good property which has minor negative features.

Where the total maximum rating is out of 1000, for example, the following assessments may be determined that
under 400—Bad.
400-600—Caution.
600-699—Maybe OK.
700-799—Very Good.
800-899—One of the Best of its Type
900+—Rare Gem.

Step 4

Finally the targeted property has all the MONEY questions asked of it. How much? When deciding on an amount to pay, the present invention assesses at least four things, such as:
What people are paying now for similar
What people are paying for alternatives
Risk involved in the purchase and amount—renovations and proposed length of hold are two risk factors but there are many more
Personal factors of the user with regards to this property, and/or
Other relevant factors.

Of course no matter how good a property is if you pay way too much you lessen the long term growth prospects of that property. The present invention allows you to compare like with like to

1. What is might be worth to others

2. What it is worth to you

By contrast, missing hidden or undervalued gems is not great for long term wealth creation. You need to know HOW MUCH something maybe worth in the FUTURE even if it not obvious now. By combining the Property Ratings Assessment tool and the Money Tool (Property Ratings DATABASE) it answers these questions. Alternatively by using PROPERTY RATINGS far more extensive database you can compare properties that have been Property Ratings rated and bought against your target property. If the property fails any of tests then it can fail overall or it can still be purchased—that is still the user/buyer's decision. BUT YOU KNOW in advance the real issues.

### EXAMPLE TWO

A period home at 12 Home Street Waterfront (a desirable suburb of a large capital city)

Buyer wants to buy a period home in the area to send children to school and this purchase is their 5th home and represents about 20% of their assets

Price is Comparable with similar properties

| Property | | Minimum | Maximum | Example | Response |
|---|---|---|---|---|---|
| Fundamental | Group | Points | Points | 12 Home St | (Value) |
| | Suburb/County/Town | | 300 | | 280 |
| | Position within | | 300 | | 230 |
| | Land Component | | 200 | | 170 |
| | Building | −100 | 200 | | 120 |
| | WOW | −300 | 200 | | 40 |
| PROPERTY | | | | | 840 |
| FUNDAMENTALS | | | | | |
| Rating | | | | | |
| Your Needs | Affordability | −300 | 300 | | 300 |
| | Position Goals | | 300 | | 280 |
| | Building Goals | | 200 | | 100 |
| | Risk Goals | −200 | 200 | | 150 |
| | Psyche and | −200 | 200 | | 150 |
| | Experience | | | | |
| YOUR NEEDS | | | | | 980 |
| Rating | | | | | |
| Price Rating | Comparables | −250 | 250 | | 200 |
| | Cashflow | −250 | 250 | | 200 |
| | Length of Hold | −300 | 300 | | 300 |
| | Timing and Median | | 100 | | 0 |
| | Risk | −300 | 100 | | −80 |
| Money Rating | | | | | 620 |

PROPERTY Characteristics Rating

In the example above, the property category 41 has a 840 Rating out of a possible 1000 value and a 4 star category rating * ie Top 20% of similar rated properties and has very good Demand and Supply fundamentals.

YOUR NEEDS Rating

In the example above, the your needs category 42 has a 980 Rating out of a possible 1000 value indicating it meet the buyer requirements very well. However this rating will probably be expressed in written form rather than as a numerical rating

Money Rating

In the example above, the money value category 43 has a 620 Rating out of a possible 1000 value indicating the asking or estimated price (the rating can operate on either price) is acceptable

The resultant overall Rating 50 would be 840+980+620=2440 out of a possible 3000, and thus it may be considered a ‘good’ buy. However this in time maybe expressed as either

One of the ratings only

The lowest rating only as the overall rating

Or an average (weighted or otherwise) rating

### EXAMPLE THREE

A poorly built apartment at 301/680 Gordy Street Willwood (a regional hinterland area)

Buyer wants to invest—there is their first time and it represents all their savings

Price is Comparable with similar properties but a lot higher than older properties in the area.

| Property | | Minimum | Maximum | | Response |
|---|---|---|---|---|---|
| Fundamental | Group | Points | Points | 301/680 Gordy St | (Value) |
| | Suburb/County/Town | | 300 | | 150 |
| | Position within | | 300 | | 150 |
| | Land Component | | 200 | | 30 |
| | Building | −100 | 200 | | 50 |
| | WOW | −300 | 200 | | −50 |
| PROPERTY | | | | | 330 |
| FUNDAMENTALS | | | | | |
| Rating | | | | | |
| Your Needs | Affordability | −300 | 300 | | 250 |
| | Position Goals | | 300 | | 200 |
| | Building Goals | | 200 | | 150 |
| | Risk Goals | −200 | 200 | | −150 |
| | Psyche and | −200 | 200 | | 40 |
| | Experience | | | | |
| YOUR NEEDS | | | | | 490 |
| Rating | | | | | |
| Price Rating | Comparables | −250 | 250 | | 230 |
| | Cashflow | −250 | 250 | | −100 |
| | Length of Hold | −300 | 300 | | −100 |
| | Timing and Median | | 100 | | 80 |
| | Risk | −300 | 100 | | −180 |
| Money Rating | | | | | −70 |

PROPERTY FUNDAMENTALS Rating

In the example above, the property category 41 has a 330 Rating out of a possible rating of 1000 and a 1 star category rating ie bottom 20% of similar rated properties and has poor Demand and Supply fundamentals

YOUR NEEDS Rating

In the example above, the your needs category 42 has a 490 Rating out of a possible 1000 value indicating it's a maybe on buyer requirements but certainly not a standout.

Money Rating

In the example above, the money value category 43 has a −70 rating out of a possible 1000 value indicating that even though it rates well against similar properties sold in the immediate area it does not represent good value overall

The resultant overall Rating 50 would be 330+490−70=750 out of 3000, thus it is considered a ‘poor’ buy.

Reports

1. Could be a simple Property Fundamentals Rating and Category Star

2. A More detailed report including
a. Strengths and weaknesses and things to do
b. A rating EXPLANATION of whether or not you should consider the property
c. Gives you a checklist on what to consider from here

A star rating may come from a database, be user selected and/or recorded ratings for that particular category of property and how the selected property fits within that category of properties.

Here are some standard category examples:
Category One—Apartments below a Country's trigger price
Category Two—Apartments above the Country's trigger price
Category Three—Townhouses below a Country's trigger price
Category Four—Townhouses above the Country's trigger price
Category Five—Houses below a Country's trigger price
Category Six—Houses above the Country's trigger price

A trigger price is the price similar to a median price that is selected each year by a ratings company responsible for that country and/or be user selected
Category One—Offices below a Country's trigger price
Category Two—Offices above the Country's trigger price
Category Three—Retail shops below a Country's trigger price
Category Four—Retail shops above the Country's trigger price
Category Five—Factories below a Country's trigger price
Category Six—Factories above the Country's trigger price

But with detailed databases kept it will be possible to have an infinite number of categories.

An example star rating is as follows

| | |
|---|---|
| [symbol] [symbol] [symbol] [symbol] [symbol] | Top 20% overall Property Fundamentals rating in that |
| | category |
| [symbol] [symbol] [symbol] [symbol] | Next 20% overall Property Fundamentals rating in that |
| | category |
| [symbol] [symbol] [symbol] | Next 20% overall Property Fundamentals rating in that |
| | category |
| [symbol] [symbol] | Next 20% overall Property Fundamentals rating in that |
| | category |
| [symbol] | Bottom 20% overall Property Fundamentals rating in that |
| | category |

This star rating and/or the summed numerical value may be used in advertising to indicate some information regarding a property or a number of properties.

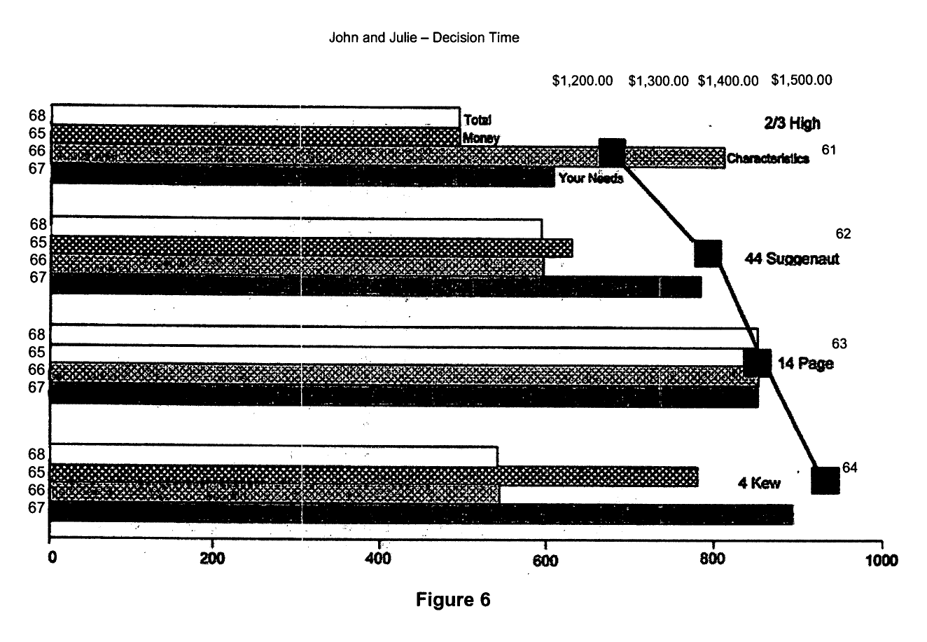

FIG. 6 illustrates an alternative example of the visual display of a number of property ratings. The display provides a ranking of the displayed properties, 61, 62, 63 and 64. For each property an indication of the rating is shown (in this example by way of bars in the graph 65 (money), 66 (property characteristics) and 67 (your needs), and a total 68. FIG. 4 also includes an overlay of the estimated price of each property.

In the example illustrated, the rating indicates that property 63 is the better in ranking overall given that it has the majority of ratings 65, 66, 67, 68 at the higher level compared to the other properties 61, 62 and 64.

Alternative representations of the rating may include numerical figures, colours, stars, tick systems and/or graphs. Other suitable or selected formats for expressing property ratings and corresponding rank of properties may also be adopted without departing from the scope of the present invention.

The method(s) and/or embodiments of the present invention may be enabled via the Internet and/or a website, in which case a user logs into a website, and can provide response (with corresponding values) to questions, the rating then being calculated and/or displayed based on those values. The assessment criteria may input by the user, and/or be stored on a database and loaded as required for use in determining the property rating and the ranking of properties.

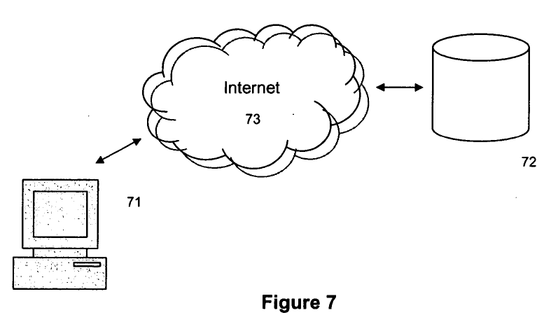

FIG. 7 illustrates one embodiment of a website based system, in which a user 71 may access a database 72 via the internet 73. The database 72 contains assessment criteria which can be used in the rating of a property.

The database helps to record the “characteristics” of the property in a searchable manner, for example but not limited to:

Street

Quiet
Norm
Busy
   Position
Excel
Good
OK
Poor
   WOW
Water
Build
Position
Land
Negative
Views
Normal
   Type
Small Unit
Large Unit
Small House
Medium House
Large House
   Style
Period
1930's—Deco and Cal Bung
40's-60's
70's-80's
Modern
Architectural.
Other
   Bed
1
2
3
3+s (study)
4
4+s
5+
   Bath
1
1+e (en suite)
2
2+e
3+
   Car
1
1G (Garage)
2
2G
3
   Levels or Storeys
1
1+S (>1 stairs internal to floor plan not to second level or at entrance or out back)
2
2+S
3
   Renos (Renovations)
major
cosmetic
none
   Yardsize (Does Not Describe Features Only to Give Better Idea of Size than Sqm)
none
balcony
Very small or poor
court yard
grass
pool+
Tennis court
   Cladding
brick
timber
mixed
other
   Floor Plan
Excel
Good
50/50
Poor
   Quality
Poor
Good
Excel
   Estimate
300000-400000
400001-500000, etc

For example, a user may log onto the database 72 and be asked certain questions reflecting assessment criteria, and provide responses. The responses enable a numerical value to be attributed to the assessment criteria (or at least some of them) and a rating may be calculated according to the method(s) as herein disclosed.

Alternatively, the user may have an application resident on their computer 71 and upload assessment criteria or a selection of assessment criteria from the database 72 (or from any other suitable means) for use in executing the application according to the method (s) as herein disclosed.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of calculating a property rating attributable to a property, the method comprising the steps of:
determining assessment criteria for use in the rating
attributing a first numerical value to at least a portion of the assessment criteria,
providing a second numerical value to the at least a portion of assessment criteria, and
determining the rating according to the second numerical value.

2. A method as claimed in claim 1, wherein the first value is a maximum value attributable to the assessment criteria.

3. A method as claimed in claim 2, wherein the first value is a set value attributable to at least one assessment criteria.

4. A method as claimed in claim 2, wherein the first value is a user definable value attributable to at least one assessment criteria.

5. A method as claimed in claim 1, wherein the second value is less than or equal to the first value.

6. A method as claimed in claim 1, wherein the second value is attributed as a response to a question.

7. A method as claimed in claim 1, wherein the step of determination has a selected bias.

8. A method as claimed in claim 7, wherein the bias is user selectable.

9. A method as claimed in claim 1, wherein the assessment criteria comprises any one or any combination of:
property characteristics
your needs
money value

10. A method as claimed in claim 1, wherein the assessment criteria comprises objective criteria.

11. A method as claimed in claim 1, wherein the assessment criteria comprises subjective criteria.

12. A method of a ranking a plurality of properties, the method comprising the steps of:
calculating a first rating corresponding to a first property,
calculating a second rating corresponding to at least a second property,
correlating the first and second ratings based on a numerical value.

13. A method as claimed in claim 12, wherein at least one rating is calculated according to the method as claimed in claim 1.

14. A method as claimed in claim 12, wherein the correlation is provided in a visual and/or indicia format.

15. An application adapted to determine a property rating, the application comprising:
first selection means adapted to enable a determination of assessment criteria for use in the rating,
second selection means adapted to attribute a first numerical value to at least a portion of the assessment criteria,
logic means adapted to record a second numerical value corresponding to the at least a portion of assessment criteria, and to determine the rating according to the second numerical value.

16. An application as claimed in claim 15, wherein the first value is a maximum value attributable to the assessment criteria.

17. An application as claimed in claim 15, wherein the second value is less than or equal to the first value.

18. An application as claimed in claim 15, wherein the second value is attributed as a response to a question.

19. An application as claimed in claim 15, wherein the determination has a selected bias.

20. An application as claimed in claim 19, wherein the bias is user selectable.

21. An application as claimed in claim 15, wherein the assessment criteria comprises any one or any combination of:
property characteristics
your needs
money value

22. An application as claimed in claim 15, wherein the assessment criteria comprises objective criteria.

23. An application as claimed in claim 15, wherein the assessment criteria comprises subjective criteria.

24. An application adapted to provide a ranking a plurality of properties, the application comprising:
enabling a first rating to be calculated corresponding to a first property,
enabling a second rating to be calculated corresponding to at least a second property,
correlating the first and second ratings based on a numerical value.

25. An application as claimed in claim 24, wherein at least one rating is calculated according to the method as claimed in claim 1.

26. An application as claimed in claim 24, wherein the correlation is provided in a visual and/or indicia format.

27. An application as claimed in claim 15 or 24 being assessable via the internet.

28. An application as claimed in claim 15 or 24 being enabled via a web site.

29. A system adapted to provide a property rating, the system including an application as claimed in claim 15 or 24.

30. A system as claimed in claim 29, wherein the application is accessed via the Internet.

31. A system as claimed in claim 29, further comprising a database adapted to provide assessment criteria.

32. A rating attributable to a property, the rating comprising a numerical value based on user input.

33. A rating as claimed in claim 32, wherein the user input is in response to assessment criteria.

34. A rating as claimed in claim 32, being determined in accordance with the method as claimed in claim 1.

35. Apparatus adapted to rate a property, said apparatus including:
processor means adapted to operate in accordance with a predetermined instruction set,
said apparatus, in conjunction with said instruction set, being adapted to perform the method as claimed in claim 1.

36. A computer program product including:
a computer usable medium having computer readable program code and computer readable system code embodied on said medium for operating in conjunction with a data processing system, said computer program product including:
computer readable code within said computer usable medium for enabling operation of a method as claimed in claim 1.
